(19) United States
(12) Patent Application Publication
(10) Pub. No.: US 2010/0125741 A1
(43) Pub. Date: May 20, 2010

(54) OPTICAL DISC EMULATOR

(75) Inventors: Tim Rausch, Gibsonia, PA (US); Paul Marvin Sweazey, Lyons, CO (US); David Scott Seekins, Allison Park, PA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: SEAGATE TECHNOLOGY LLC, Scotts Valley, CA (US)

(21) Appl. No.: 12/274,554

(22) Filed: Nov. 20, 2008

(51) Int. Cl. G06F 12/14

(52) U.S. Cl. 713/193

(57) ABSTRACT

A system and method that maps an emulated optical disc file structure to a secure region of a data storage device, and translates cryptographic challenges received from a media player licensed under a digital rights management specification into firmware command sets of the data storage device.

### BACKGROUND

The present disclosure relates to the field of digital rights management. In particular, the present disclosure relates to systems and methods for making authorized recordings of protected content.

Current Digital Versatile Disc (DVD) media and high definition media (e.g., Blu-Ray and HD-DVD standards) may be protected by several different digital rights management specifications. Standard DVD media are typically protected by the Content Scramble System (CSS), while Blu-Ray and HD-DVD media are typically protected using the Advanced Access Control System (AACS) specification. Both content providers and content creators have recognized the need to allow users to make copies of their content for backup purposes and convenience. With a wide variety of personal video players being commercially available in the market, many consumers wish to copy their premium video contents to these devices. In addition, consumers are increasingly excited by the proposition of having large video jukeboxes in their home that allow them to browse and play their video catalog from anywhere in their homes without the need of the particular media.

The AACS specification currently includes a process referred to as “Managed Copy”, in which consumers may make authorized copies of digital content protected under the AACS specification. The Managed Copy process involves contacting a remote managed copy server over the Internet and obtaining authorization to make the copy. Through this process, the resulting copy is also protected by a digital rights management specification, thereby preventing subsequent unauthorized copying of the content. However, the Managed Copy process requires that the resulting copy is made using a licensed “Managed Copy Output Technology” (MCOT) specification. Attaining approval of a licensed MCOT specification is a time consuming process, which makes it difficult to commercially enter new products into the market for attaining authorized copies of protected content. Thus, there is a need for systems and techniques for using current licensed MCOT specifications to attain authorized copies of protected content with new data storage media.

### SUMMARY

An aspect of the disclosure is directed to a computer-based system that includes a data storage device having a device encryption key for encrypting at least one secure region of data blocks, and an emulator application configured to emulate an optical disc file structure and to map the data blocks of the at least one secure region to the emulated optical disc file structure. The emulator application is further configured to communicate with a media player licensed under a digital rights management specification, and to translate cryptographic challenges received from the media player into firmware command sets of the data storage device.

Another aspect of the disclosure is directed to a method for operating a computer-based system. The method includes establishing a secure session with a data storage device, emulating an optical disc file structure, and mapping data blocks of a secure region of the data storage device to the emulated optical disc file structure. The method further includes communicating with a media player licensed under a digital rights management specification, and translating cryptographic hardware challenges from the media player into firmware command sets for the data storage device.

A further aspect of the disclosure is directed to a method for operating a computer-based system, which includes initiating an emulator application that is functionally interposed between a media player licensed under a digital rights management specification and a data storage device of the computer-based system, where the emulator application emulates an optical disc file structure. The method further includes establishing a secure session between the emulator application and the data storage device, where the data storage device comprises a secure region of data blocks, mapping the secure region of data blocks to the emulated optical disc file structure, and translating cryptographic challenges from the media player to firmware command sets of the data storage device.

### BRIEF DESCRIPTION OF THE DRAWINGS

FIG. 1 is a schematic illustration of a computer-based system for making authorized recordings of protected content and for providing authorized playbacks of the protected content.

FIG. 2 is a flow diagram of a method for making an authorized recording of a protected content to a data storage device.

FIG. 3 is a flow diagram of a method for providing an authorized playback of the protected content from the data storage device.

### DETAILED DESCRIPTION

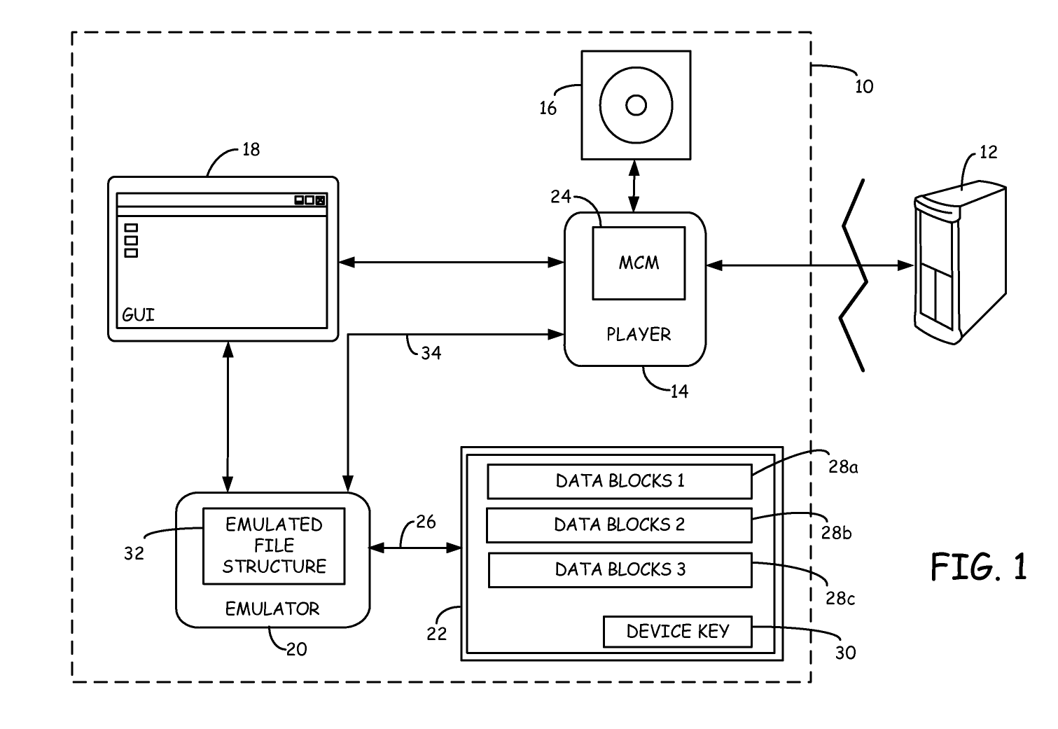

FIG. 1 illustrates system 10 in use with Managed Copy Server (MCS) 12, where system 10 is a computer-based system that is suitable for making authorized recordings of protected content onto a variety of data storage media beyond optical discs. Furthermore, system 10 is also suitable for providing authorized playbacks of the protected content recorded from the data storage media. As shown, system 10 includes media player 14, which is desirably a software-based, multi-media player licensed under a digital rights management specification. As used herein, the phrase “licensed under a digital rights management specification” for a media player refers to the media player being capable of operating pursuant to the requirements of the given digital rights management specification.

The following discussion of system 10 is made with reference to the AACS specification with the understanding that system 10 may be used with a variety of different digital rights management specifications (e.g., the Content Scramble System (CSS) specification). However, system 10 is particularly suitable for use with digital rights management specifications that provide “Managed Copy” processes, such as the AACS specification. Suitable methods for the standard playback and recording of protected contents with an optical disc drive under the AACS specification are disclosed in Advanced Access Content System, Blu-Ray Disc Pre-Recorded Book, Rev. 0.921; Blu-Ray Disc Recordable Book, Rev. 0.921; HD DVD and DVD Pre-Recorded Book, Rev. 0.912; and HD DVD Recordable Book, Rev. 0.921.

System 10 also includes optical drive 16, graphical user interface (GUI) 18, emulator application 20, and storage device 22, where storage device 22 may be any type of non-volatile data storage device, such as hard disk drives, flash-based drives, ferroelectric drives, and the like. Optical drive 16 is an optical disc drive that is authorized to play optical media with media player 14 pursuant to the digital rights management specification (e.g., a Blu-Ray disc player). Accordingly, during a standard playback of protected content stored on an optical disc (e.g., a movie stored on a Blu-Ray disc) using optical drive 16, a user may initiate media player 14 through GUI 18. For example, the user may access media player 14 through an operating system interface of system 10. Pursuant to the digital rights management specification, media player 14 then sends cryptographic hardware challenges to optical drive 16 to confirm that optical drive 16 is an optical disc drive capable of making authorized recordings.

Optical drive 16 then sends responses to the challenges back to media player 14, and media player 14 then verifies that the responses are correct. Optical drive 16 also sends information relating to the stored protected content to media player 14, such as media key blocks (MKB) and key conversion data (KCD). Upon verification that the responses to the cryptographic challenges are correct, optical drive 16 sends the protected content to media player 14 in the desired order needed for playback. Media player 14 then decrypts the received content (e.g., with the MKB and KCD), and plays the protected media until the user stops the playback.

Similarly, if the user desires to make an authorized copy of the protected content onto an additional optical disc (e.g., a second Blu-Ray disc, not shown), the user may initiate media player 14 through GUI 18, which sends the cryptographic hardware challenges to optical drive 16, as discussed above. When media player 14 verifies that the responses to the challenges are correct, media player 14 obtains the desired uniform resource locator (URL) from the original optical disc, or otherwise uses a default URL if the optical disc does not contain a specific URL. Based on the obtained URL, media player 14 initiates Managed Copy Machine (MCM) 24, which contacts MCS 12 over an Internet network to receive authorization to make the recording. This allows the owner of the protected content, or respective agent, to be notified of the additional recording, and to authorize the recording. Upon receipt of authorization from MCS 12 to make the recording, MCM 24 copies the protected content onto the additional optical disc using a licensed MCOT specification. When the recording process is complete, the resulting optical disc contains the recorded content, which is also protected under the digital rights management specification, and may be played back in the same manner as discussed above.

In addition to the standard recording and playback capabilities allowed under the digital rights management specification, system 10 also allows a user to make an authorized recording of the protected content onto storage device 22, and to play the protected content back with media player 14. This allows users to make authorized recordings onto non-optical discs, thereby increasing the types of media that may be used without requiring the acquisition of a new MCOT specification. This is particularly suitable for storage media capable of retaining large volumes of information, such as hard disk drives, which may then function as media centers for large-file media (e.g., HD-DVD and Blu-Ray-based movies).

System 10 is capable of recording the protected content from an optical disc to storage device 22 by emulating the file structure of an optical disc when interacting with a media player licensed under a digital rights management specification (e.g., media player 14). As such, media player 14 interacts with emulator application 18 and storage device 22 as if the combination of emulator application 18 and storage device 22 is an actual optical disc drive that contains a blank optical disc. Emulator application 18 is desirably a software-based application that may be initiated by a user through graphical user interface 18. When initiated, emulator application 18 establishes a secure session with storage device 22 over one or more secure data lines (referred to as data line 26). Data line 26 may be a variety of different electrical and/or wireless connections, such as a serial-ATA bus line. The secure session may be established pursuant to standard encryption protocols, and is desirable to reduce the risk of data tampering.

When a user of system 10 desires to make an authorized copy of the protected content from optical drive 16 to storage device 22, emulator application 20 partitions and formats a secure region of data blocks (e.g., secure region 28a) for binding the recorded content to storage device 22. Examples of suitable storage media capable of encrypting one or more data regions include hard disk drives commercially available under the trade designation “MOMENTUS” 5400 FDE.2 Hard Drives from Seagate Technology, LLC, Scotts Valley, Calif. In one embodiment, this is accomplished with the use of device key 30, which is a device encryption key that is stored on storage device 22, and that is desirably only accessible by emulator application 20 when a secure session is established. In this embodiment, secure region 28a is encrypted with the encryption protocols of device key 30, thereby preventing access to secure region 28a by programs other than emulator application 20. This desirably prevents users from accessing data stored in data region 28a (e.g., recorded protected content) to reduce the risk of unauthorized recordings being made.

As used herein, the term “secure region” refers to one or more locations of data blocks on a data storage device. For example secure region 28a may include an arrangement where all of the data blocks are located in a single location of storage device 22 (e.g., a group of adjacent tracks and data sectors). Alternatively, the data blocks may be located over multiple locations of storage device 22 (e.g., over multiple data sectors of a hard disk and/or over multiple hard disks of a stacked hard disk drive). The data blocks of the data storage device may be specified pursuant to a logical block addressing scheme.

When secure region 28a is formatted and decrypted with device key 30, emulator application 20 may generate emulated file structure 32, which is an emulated optical disc file structure (e.g., a file structure corresponding to the universal disk format (UDF) specification). Emulator application 20 then maps the data blocks of secure region 28a to emulated file structure 32, which allows data to be transferred to and from storage device 22 based on an optical disc file structure. Emulator application 20 may also communicate with media player 14 via data line 34, and functions as an interposer application between media player 14 and storage device 22 such that media player 14 operates as if emulator application 20/storage device 22 is a blank optical disc in an optical disc drive.

As discussed above, during an authorized recording operation, media player 14 sends cryptographic hardware challenges to the intended recording device. Thus, media player 14 sends the cryptographic hardware challenges to emulator application 20. The cryptographic hardware challenges may vary depending on the digital rights management specification used, and typically require the responses to the challenges be performed by hardware rather than software. For example, under the AACS specification, the challenges may relate to optical disc drive attachment interfaces (e.g., ATAPI protocols) and Mt. Fuji command sets. In addition to generating emulated file structure 32, emulator application 20 also desirably translates the cryptographic hardware challenges from optical disc drive hardware requirements to firmware command sets capable of being performed by storage device 22. Emulator application 20 then sends the translated challenges to storage device 22 via data line 26. Because the translated challenges are provided to storage device 22 as firmware command sets, the challenges may be performed by the hardware of storage device 22 in the same manner as for an optical disc drive. Responses that the challenges were properly performed in hardware are sent then back to emulator application 20 via data line 26, and emulator application 20 relays them to media player 14 via data line 34.

When media player 14 verifies the responses to the cryptographic hardware challenges, media player 14 obtains the desired URL from the optical disc retained in optical disc drive 16, or otherwise uses a default URL if the optical disc does not contain a specific URL. Based on the obtained URL, media player 14 initiates MCM 24, which contacts MCS 12 over an Internet network to receive authorization to make the recording. As discussed above, this allows the owner of the protected content, or respective agent, to be notified of the additional recording, and to authorize the recording. Because media player 14 operates as if emulator application 20/storage device 22 is a blank optical disc in an optical disc drive, MCS 12 and MCM 24 function as if media player 14 verified the cryptographic hardware challenges for an optical disc drive.

In one embodiment, emulator application 20 and/or storage device 22 may also send information to media player 14 relating to the identification of storage device 22. This allows MCM 24 to submit such information to MCS 12, thereby informing the owner of the protected content that protected content is to be recorded and bound to a secure data storage device (i.e., storage device 22) rather than an optical disc. With this embodiment, emulator application 20 desirably limits the amount of information provided to media player 14 to alleviate privacy concerns for the user.

Upon receipt of authorization from MCS 12 to make the recording, MCM 24 then relays the protected content from the optical disc in optical disc drive 16 to emulated file structure 32 of emulator application 20 using the licensed MCOT specification. Emulator application 20 then relays the data to the data blocks in secure region 28a based on the previously generated mapping between emulated file structure 32 and secure region 28a. This allows the data of the protected content to be recorded in the data blocks of secure region 28a. In addition to the protected content, information required for authorized playback of the protected content is also desirably recorded to secure session 28a. For example, MCM 24 may also generate or relay the media key blocks (MKB) and key conversion data (KCD) of the protected content to emulator application 20 and storage device 22.

When the recording process is complete, emulator application 20 may generate an ISO image of the data blocks of secure region 28a, and desirably writes the ISO image to the data blocks of secure region 28a (or of another secure region). The ISO image allows emulator application 20 to recreate emulated file structure 32 during a subsequent playback operation. Emulator application 20 may then close the secure session with storage device 22. As discussed above, secure region 28a is desirably encrypted with device key 30, thereby preventing access to secure region 28a when a secure session between emulator application 20 and storage device 22 is not established. This binds the protected data to storage device 22 and prevents users from accessing the recorded protected content outside of the secure session, thereby reducing the risk of unauthorized recordings and playback of the protected content. Thus, in addition to maintaining the copy and playback protection under the digital rights management specification, the protected content also remains securely bound to storage device 22 in the same manner as if the protected content were copied to an optical disc. Accordingly, when viewed by a user through GUI 18, the ISO image of secure region 28a may visually appear as an optical drive that is separate from storage device 22, and which contains an optical disc with the protected content.

The above-discussed authorized recording process may be performed for protected contents from a plurality of optical discs, thereby creating a plurality of secure regions (e.g., secures regions 28b and 28c). Each of the secure regions is desirably encrypted with device key 30, thereby binding each protected content to storage device 22. As a result, storage device 22 may function as a media center for retaining a plurality of protected contents. For example, in embodiments in which storage device 22 is a hard disk drive, system 10 may retain multiple HD and/or Blu-Ray format movies, which would otherwise require multiple optical discs. This increases the ease of use and portability (e.g., with portable computer devices) of legally-obtained media that is protected under one or more digital rights management specifications.

During a subsequent playback operation, the user may initiate emulator application 20 via GUI 18 for playback of one or more of the protected contents stored in secure regions 28a-28c. When initiated, emulator application 18 reestablishes a secure session with storage device 22 over data line 26, and decrypts one of the secure regions (e.g., secure region 28a) using device key 30. This allows emulator application 18 to recreate emulated file structure 32 from the ISO image stored in the secure region, and to map the data blocks of the secure region to emulated file structure 32.

Emulator application 20 may then communicate with media player 14 via data line 34 to play the protected content through media player 14. Pursuant to the digital rights management specification, media player 14 resends the cryptographic hardware challenges to emulator application 20. Emulator application 20 then translates the challenges into firmware command sets for storage device 22, which accordingly provides the hardware-based responses. These responses are relayed back to emulator application 20, and emulator application 20 relays them to media player 14 via data line 34. Media player 14 then verifies the responses to the cryptographic hardware challenges. Media player 14 may also request playback information for the protected content stored in secure region 28a, such as media key blocks (MKB) and key conversion data (KCD). The playback information may be required because certain digital rights management specifications (e.g., the AACS specification) maintain an encryption of the protected content until decrypted by the media player (e.g., media player 14). Thus, in these embodiments, even after secure region 28a is decrypted with device key 30, the protected content may remain encrypted until playback with media player 14. This further reduces the risk of data tampering during playback.

The playback information is relayed to media player 14, and the protected content is relayed from storage device 22 to emulator application 20 in the order needed for playback. Emulator application 20 remaps the received protected content to emulated file structure 20 for submission to media player 14. Media player 14 then decrypts the received content (e.g., with the MKB and KCD), and plays the content until the user stops the playback. When playback is stopped, emulator application 20 unmounts the ISO image and closes the secure session with storage device 22. Closing the secure session allows the secure regions (e.g., secure regions 28a-28c) to remain encrypted on storage device 22. As discussed above, this binds the protected content to storage device 22 in the same manner as if the protected content were recorded to an optical disc.

The above-discussed computer applications (e.g., media player 14, GUI 18, emulator application 20, and MCM 24), the generated file structures (e.g., emulated file structure 32), and the relayed data (e.g., the translated challenges and responses) may be stored on a variety of physical media, such as volatile and non-volatile media, and removable and non-removable media. The stored information may also be implemented in using a variety of methods or technologies for storage of information, such as computer readable instructions, data structures, program applications, and the like.

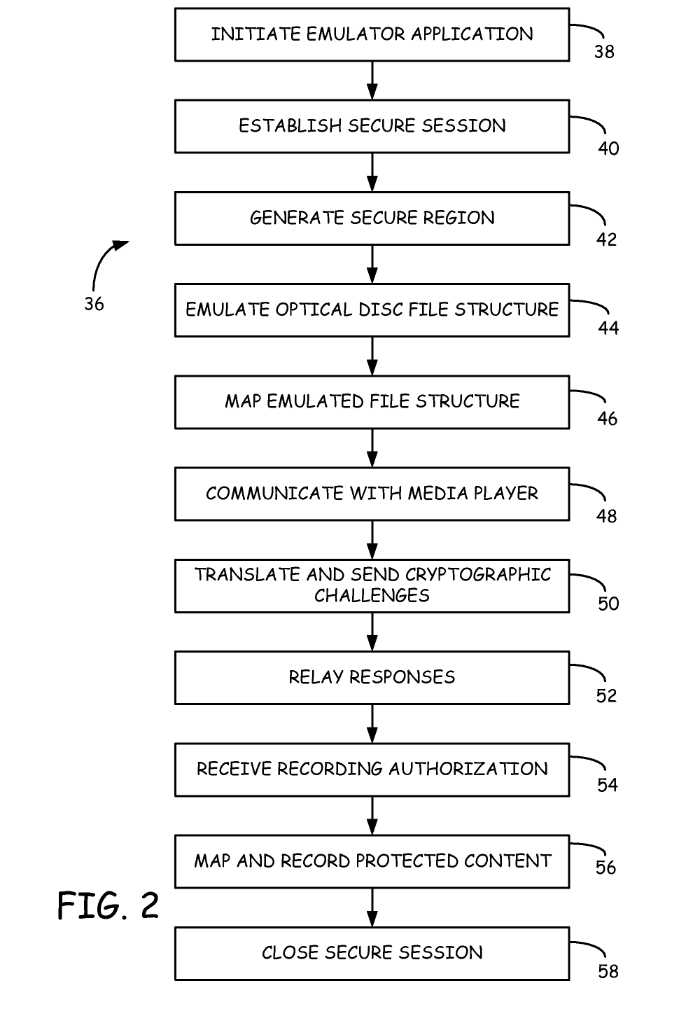

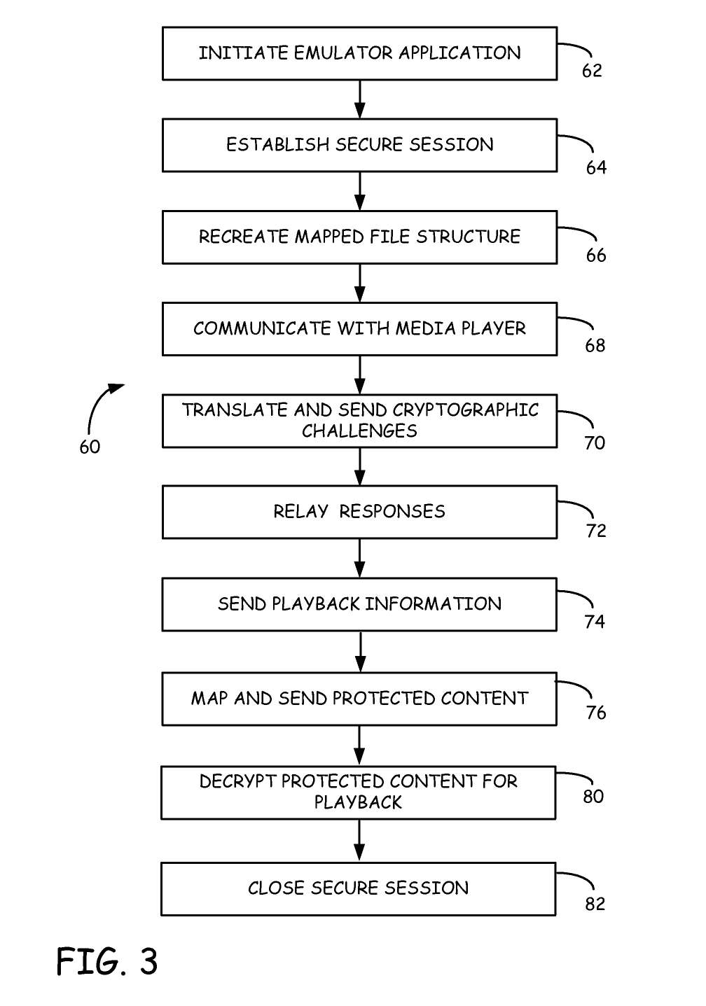

FIGS. 2 and 3 are flow diagrams of method for making an authorized recording of a protected content (FIG. 2), and for playing the authorized recording from the data storage device with a media player licensed under a digital rights management specification (FIG. 3). As shown in FIG. 2, method 36 for making an authorized recording includes steps 38-58, and initially involves initiating an emulator application (e.g., emulator application 20, shown in FIG. 1) (step 38) and establishing a secure session with a data storage device (step 40). A secure region of data blocks may then be generated, desirably with the use of a device encryption key, as discussed above (step 42). The emulator application may then emulate an optical disc file structure, such as a UDF file structure (step 44), and map the data blocks of the secure region of the data storage device to the emulated optical disc files structure (step 46). Generating the secure region in the data storage device and emulating the optical disc file structure, pursuant to steps 44 and 46 of method 36, may be performed in either order or in a simultaneous manner.

The emulator application may then communicate with a media player licensed under a digital rights management specification (e.g., an AACS specification) (step 48). As discussed above, emulating an optical disc file structure, and mapping this file structure to the data blocks of the secure region allows the media player to function as if the combined emulator application/data storage device are an optical disc drive containing a blank optical disc. While communicating with the media player, the media player sends cryptographic challenges to the emulator application, where the cryptographic challenges are typically optical drive hardware challenges. The emulator application translates these cryptographic challenges into firmware command sets, and sends the translated challenges to the data storage device (step 50). The data storage device then performs the firmware-based challenges, and sends responses to the challenges back to the emulator application. The emulator application then relays them to the media player for verification (step 52).

Upon verifying that the challenges were met, the media player may communicate with a managed copy server (MCS) to receive authorization for perform the recording process (step 54). In one embodiment, step 54 may involve initiating a managed copy machine (MCM) to communicate with the managed copy server. Alternatively, step 54 may be omitted for digital rights management specifications that do not incorporate MCS-based authorizations. Upon receipt of the recording authorization, the protected content is copied from an original source relayed to the emulator application. As discussed above, the original source may be an original optical disc. Additionally, method 36 may be used to record protected contents form a variety of different sources, such as Internet-based sources. For example, the manage copy server may also include a function in which the protected content may be purchased and downloaded from a remote source location. However, because the media player functions as if the combined emulator application/data storage device are an optical disc drive containing a blank optical disc, the protected content is typically provided in an optical disc file structure using an MCOT specification.

Upon receipt of the protected content, the emulator application may map the received data to the data blocks of the secure region of the data storage device (step 56). The emulator application also desirably relays information required for authorized playback of the protected content (e.g., the MKB and KCD information). When the recording operation is complete, the emulator application may write an ISO image of the recorded content to the secure region and close the secure session (step 58). The protected content is then bound to the data storage device, and may only be subsequently played back or re-recorded pursuant to the digital rights management specification used.

In addition to allowing authorized copies of protected content to be recorded to a data storage device, method 36 is also suitable for providing secure data storage for any kind of digital data. Once an optical disc file structure is emulated and mapped to a secure region of the data storage device, the user may copy a variety of documents to the secure region and have it protected with the same protection that an optical disc offers pursuant to a digital rights management scheme. Furthermore, method 36 is also suitable for allowing authorized copies of protected content to be recorded from one data storage device (e.g., storage device 22) to an additional data storage device. This allows the protected content to be transferred to variety of different data storage devices, such as portable video players, while retaining the protection that an optical disc offers pursuant to a digital rights management scheme.

As shown in FIG. 3, method 60 for playing the authorized recording from the data storage device includes steps 62-82, and initially involves initiating the emulator application (step 62) and establishing a secure session with the data storage device (step 64). The emulator application may then read the ISO image of the data stored in the secured region of the data storage device to recreate the mapped file structure (step 66). This emulates the optical disc file structure and maps this file structure to the data blocks of the secure region.

The emulator application may then communicate with the media player (step 68), where the media player sends cryptographic challenges to the emulator application, as discussed above. The emulator application translates these cryptographic challenges into firmware command sets, and sends the translated challenges to the data storage device (step 70). The data storage device then performs the firmware-based challenges, and sends responses to the challenges back to the emulator application. The emulator application then relays them to the media player for verification (step 72). The emulator application also reads the additional playback information (e.g., MKB and KCD information) from the data storage device, and sends the additional information to the media player (step 74).

Upon verifying that the challenges were met, the media player may then read the protected content from the data storage device (via the emulator application) (step 76). The emulator application maps the data blocks of the storage device to the optical disc file structure, thereby allowing the media player to read the protected content as is the protected content were transmitted from an optical disc. The media player then decrypts the protected content pursuant to the digital rights management specification (e.g., with the MKB and KCD information) for playback (step 80). When playback is complete, the emulator application may close the secure session with the data storage device (step 82). The user may repeat method 60 for each protected content stored on the data storage device in the same manner as if the protected content was stored on an optical disc without the need of the particular media. Accordingly, the protected content remains bound to the data storage device and retains the encryption protections available the digital rights management specification used, while also increasing the versatility of use with a variety of data storage devices.

Although the present disclosure has been described with reference to preferred embodiments, workers skilled in the art will recognize that changes may be made in form and detail without departing from the spirit and scope of the disclosure.

1. A computer-based system comprising:
a data storage device comprising a device encryption key for encrypting at least one secure region of data blocks; and
an emulator application stored on a computer storage medium, and configured to emulate an optical disc file structure and to map the data blocks of the at least one secure region to the emulated optical disc file structure, wherein the emulator application is further configured to communicate with a media player licensed under a digital rights management specification, and to translate cryptographic challenges received from the media player into firmware command sets of the data storage device.

2. The system of claim 1, wherein the emulator application is further configured to establish a secure session with the data storage device.

3. The system of claim 2, wherein the device encryption key is accessible to the emulator application after the secure session is established.

4. The system of claim 1, wherein the digital rights management specification comprises an Advanced Access Control System specification.

5. The system of claim 1, wherein the data storage device comprises protected content bound to the data blocks of the at least one secure region.

6. The system of claim 1, wherein data storage device comprises a hard disk drive.

7. The system of claim 1, wherein emulator application is further configured to generate the at least one secure region of data blocks on the data storage device.

8. A method for operating a computer-based system, the method comprising:
establishing a secure session with a data storage device;
emulating an optical disc file structure;
mapping data blocks of a secure region of the data storage device to the emulated optical disc file structure;
communicating with a media player licensed under a digital rights management specification; and
translating cryptographic challenges from the media player into firmware command sets for the data storage device.

9. The method of claim 8, and further comprising recording protected content to the secure region of the data storage device.

10. The method of claim 9, and further comprising receiving authorization to record the protected content.

11. The method of claim 8, and further comprising playing protected content with the media player, wherein the protected content is stored in the secure region of the data storage device.

11. The method of claim 12, and further comprising sending playback information stored on the data storage device to the media player.

13. The method of claim 8, and further comprising encrypting the secure region of the data storage device with a device encryption key.

14. A method for operating a computer-based system, the method comprising:
initiating an emulator application retained on a first computer storage medium and functionally interposed between a media player licensed under a digital rights management specification and a data storage device of the computer-based system, wherein the emulator application emulates an optical disc file structure;
establishing a secure session between the emulator application and the data storage device, wherein the data storage device comprises a secure region of data blocks;
mapping the secure region of data blocks to the emulated optical disc file structure; and
translating cryptographic challenges from the media player to firmware command sets of the data storage device.

15. The method of claim 14, and further comprising recording protected content to the secure region of the data storage device.

16. The method of claim 15, and further comprising receiving authorization to record the protected content.

17. The method of claim 14, and further comprising playing protected content with the media player, wherein the protected content is stored in the secure region of the data storage device.

18. The method of claim 14, and further comprising encrypting the secure region of the data storage device with a device encryption key.

19. The method of claim 14, wherein the digital rights management specification comprises an Advanced Access Control System specification.

20. The method of claim 14, and further comprising:
sending the translated firmware command sets from the emulator application to the data storage device; and
performing the translated firmware command sets with the data storage device.
